(19) United States
(12) Patent Application Publication
(10) Pub. No.: US 2015/0340048 A1
(43) Pub. Date: Nov. 26, 2015

(54) VOICE PROCESSING DEVICE AND VOICE PROCESSSING METHOD

(71) Applicant: FUJITSU LIMITED, Kawasaki-shi (JP)

(72) Inventors: Chisato Shioda, Kawasaki (JP); Taro Togawa, Kawasaki (JP); Takeshi Otani, Kawasaki (JP)

(73) Assignee: Fujitsu Limited, Kawasaki (JP)

(21) Appl. No.: 14/711,284

(22) Filed: May 13, 2015

(30) Foreign Application Priority Data
May 22, 2014 (JP) 2014-105825

(51) Int. Cl. G10L 21/02

(52) U.S. Cl. CPC G10L 21/02

(57) ABSTRACT

A voice processing device, includes, a processor; and a memory which stores a plurality of instructions, which when executed by the processor, cause the processor to execute: receiving, through a communication network, a first voice of a first user and a second voice of a second user inputted to a first microphone positioned nearer to the first user than the second user, and a third voice of the first user and a fourth voice of the second user inputted to a second microphone positioned nearer to the second user than the first user; calculating a first phase difference between the received first voice and the received second voice and a second phase difference between the received third voice and the received fourth voice; and performing at least one of: controlling transmission of the received second voice or the received fourth voice to a first speaker.

### CROSS-REFERENCE TO RELATED APPLICATION

This application is based upon and claims the benefit of priority from the prior Japanese Patent Application No. 2014-105825 filed on May 22, 2014, the entire contents of which are incorporated herein by reference.

### FIELD

The embodiments disclosed herein relate to a voice processing device, a voice processing method, and a voice processing program for controlling, for example, a voice signal.

### BACKGROUND

In recent years, voice processing devices and software applications that utilize the Voice over Internet Protocol (VoIP) in which packets converted from a voice signal are transferred on the real time basis by Internet access have been and are utilized. A voice processing device or a software application that utilize the VoIP has, in addition to an advantage that communication may be performed among a plurality of users without the intervention of a public switched telephone network, another advantage that text data or image data may be transmitted and received during communication. Further, for example, in Goode, B., “Voice over Internet protocol(VoIP),” Proceedings of the IEEE, vol. 90, issue 9, September 2002, also a method is disclosed by which, in a voice processing device that utilizes the VoIP, the influence of variation of communication delay by Internet access is moderated by a buffer of the voice processing device.

Since a voice processing device that utilizes the VoIP utilizes, different from a public switched telephone network that occupies a line, an existing Internet network, a delay of approximately 300 msec occurs until a voice signal reaches as communication reception sound. Therefore, for example, when a plurality of users perform voice communication, the users far from each other hear voices of the opponents only from communication reception sound. However, the users near to each other hear voice of each other from both of communication reception sound and direct sound in an overlapping relationship in a state in which the communication reception sound and the direct sound have a time lag of approximately 300 msec therebetween. This phenomenon gives rise to a problem that it becomes rather difficult for the users to hear the sound. It is an object of the present embodiments to provide a voice processing device that makes it easier to listen to sound.

### SUMMARY

In accordance with an aspect of the embodiments, a voice processing device, includes, a processor; and a memory which stores a plurality of instructions, which when executed by the processor, cause the processor to execute: receiving, through a communication network, a first voice of a first user and a second voice of a second user inputted to a first microphone positioned nearer to the first user than the second user, and a third voice of the first user and a fourth voice of the second user inputted to a second microphone positioned nearer to the second user than the first user; calculating a first phase difference between the received first voice and the received second voice and a second phase difference between the received third voice and the received fourth voice; and performing at least one of: controlling transmission of the received second voice or the received fourth voice to a first speaker positioned nearer to the first user than the second user on the basis of the first phase difference and the second phase difference, and controlling transmission of the received first voice or the received third voice to a second speaker positioned nearer to the second user than the first user on the basis of the first phase difference and the second phase difference.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a diagram of a hardware configuration including a functional block diagram of a voice processing device according to a first embodiment;

FIG. 2 is a first flow chart of a voice process of a voice processing device;

FIG. 3 is a functional block diagram of a calculation unit according to one embodiment;

FIG. 4 is a diagram depicting a result of detection of a voiced temporal segment and an unvoiced temporal segment by a calculation unit;

FIG. 5A is a view depicting a positional relationship among a first user, a second user, a first microphone, and a second microphone;

FIG. 5B is a conceptual diagram of a first phase difference and a second phase difference;

FIG. 6 is a conceptual diagram of occurrence of an error of an estimated distance by a delay;

FIG. 7A is a conceptual diagram of first and second phase differences when a delay does not occur;

FIG. 7B is a conceptual diagram of first and second phase differences when a delay occurs in a first microphone;

FIG. 7C is a conceptual diagram of first and second phase differences when a delay occurs in both of first and second microphones;

FIG. 8 is a second flow chart of a voice process of a voice processing device;

FIG. 9A depicts an example of a data structure of a phase difference table;

FIG. 9B depicts an example of a data structure of an inter-terminal phase difference table;

FIG. 10 is a third flow chart of a voice process of a voice processing device; and

FIG. 11 is a view of a hardware configuration of a computer that functions as a voice processing device according to one embodiment.

### DESCRIPTION OF EMBODIMENTS

In the following, a working example of a voice processing device, a voice processing method, and a voice processing program according to one embodiment is described with reference to the drawings. It is to be noted that the working example does not restrict the technology disclosed herein.

### WORKING EXAMPLE 1

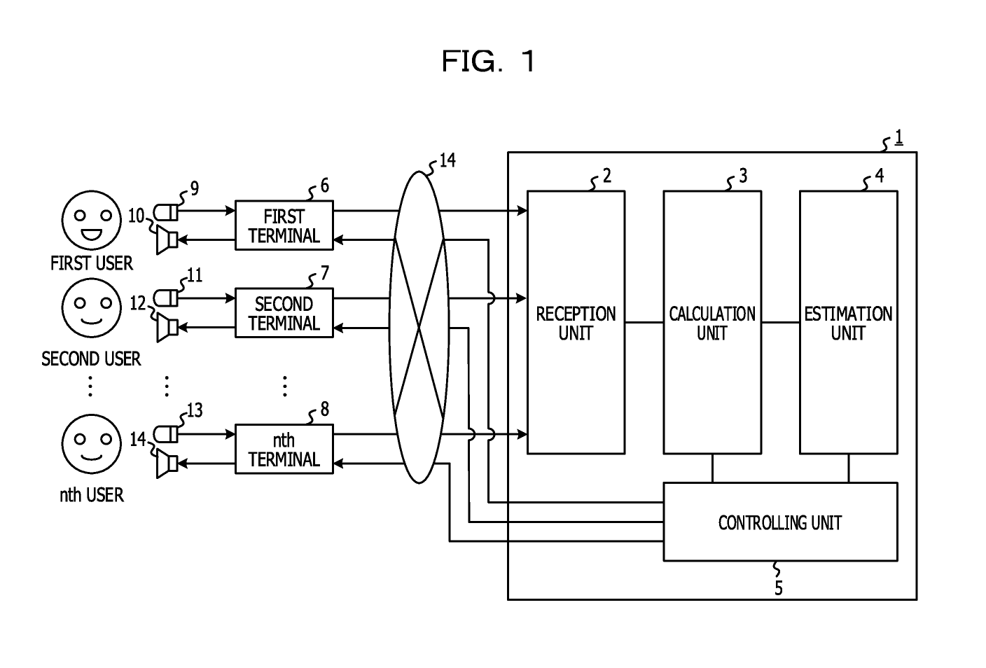

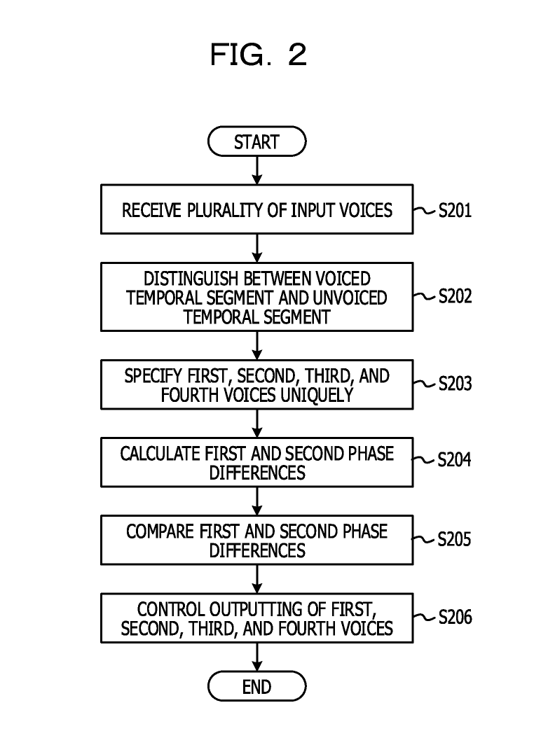

FIG. 1 is a diagram of a hardware configuration including a functional block diagram of a voice processing device according to a first embodiment. A voice processing device 1 includes a reception unit 2, a calculation unit 3, an estimation unit 4, and a controlling unit 5. To the voice processing device 1, a plurality of terminals (for example, PCs and highly-functional portable terminals into which a software application may be installed) are coupled through a network 117 of a wire circuit or a wireless circuit that is an example of a communication network. For example, a first microphone 9 and a first speaker 10 are coupled with a first terminal 6 and are disposed in a state in which the first microphone 9 and the first speaker 10 are positioned near to a first user. Further, a second microphone 11 and a second speaker 12 are coupled with a second terminal 7 and are disposed in a state in which the second microphone 11 and the second speaker 12 are positioned near to a second user. Further, an nth microphone 13 and an nth speaker 14 are coupled with an nth terminal 8 and are disposed in a state in which the nth microphone 13 and the nth speaker 14 are positioned near to an nth user. FIG. 2 is a first flow chart of a voice process of a voice processing device. In the working example 1, a flow of the voice process by the voice processing device 1 depicted in FIG. 2 is described in an associated relationship with description of functions of the functional block diagram of the voice processing device 1 depicted in FIG. 1.

In the working example 1, for the convenience of description, it is assumed that the first user and the second user exist on the same base (which may be referred to as floor) and are positioned in an adjacent relationship to each other. Further, a first voice of the first user and a second voice of the second user are inputted to the first microphone 9 (in other words, even if the first user performs utterance to the first microphone 9, also the second microphone 11 picks up the utterance). Meanwhile, a third voice of the first user and a fourth voice of the second user are inputted to the second microphone 11 (in other words, even if the second user performs utterance to the second microphone 11, also the first microphone 9 picks up the utterance). Here, the first and third voices are voices within an arbitrary time period (which may be referred to as temporal segment) within which the first user performs utterance in a time series, and the second and fourth voices are voices within an arbitrary time period (which may be referred to as temporal segment) within which the second user performs utterance in a time series. Further, the utterance contents of the first and third voices are same as each other and the utterance contents of the second and fourth voices are same as each other. In other words, where a positional relationship among the first user, second user, first microphone 9, and second microphone 11 in FIG. 1 is taken into consideration, if the first user utters to the first microphone 9, then the utterance contents are inputted as the first voice to the first microphone 9 and, at the same time, a sound wave of the utterance contents propagates through the air and then is inputted as the third voice to the second microphone 11. Similarly, if the second user utters to the second microphone 11, then the utterance contents are inputted as the fourth voice to the second microphone 11 and, at the same time, a sound wave of the utterance contents propagates through the air and then is inputted as the second voice to the first microphone 9.

The reception unit 2 is, for example, a hardware circuit configured by hard-wired logic. The reception unit 2 may alternatively be a functional module implemented by a computer program executed by the voice processing device 1. The reception unit 2 receives a plurality of input voices (which may be referred to as a plurality of voices) inputted to the first microphone 9 to nth microphone 13 through the first terminal 6 to nth terminal 8 and the network 117 as an example of a communication network. It is to be noted that the process described corresponds to step S201 of the flow chart depicted in FIG. 2. The reception unit 2 outputs a plurality of voices including, for example, the first, second, third, and fourth voices to the calculation unit 3.

The calculation unit 3 is, for example, a hardware circuit configured by hard-wired logic. The calculation unit 3 may alternatively be a functional module implemented by a computer program executed by the voice processing device 1. The calculation unit 3 receives a plurality of voices (which may be referred to as a plurality of input voices) including the first, second, third, and fourth voices from the reception unit 2. The calculation unit 3 distinguishes input voices inputted to the first and second microphones 9 and 11 between a voiced temporal segment and an unvoiced temporal segment and uniquely specifies the first, second, third, and fourth voices from within the voiced temporal segment.

First, a method for distinguishing an input voice between a voiced temporal segment and an unvoiced temporal segment by the calculation unit 3 is described. It is to be noted that the process described corresponds to step S202 of the flow chart depicted in FIG. 2. The calculation unit 3 detects a breath temporal segment indicative of a voiced temporal segment included in the input voice. It is to be noted that the breath temporal segment signifies, for example, a temporal segment after the user performs breath during utterance and then starts utterance until the user performs breath again (in other words, a temporal segment between a first breath and a second breath or a temporal segment within which utterance continues). The calculation unit 3 detects, for example, an average SNR serving as a signal power to noise ratio as an example of signal quality from a plurality of frames included in the input voice and may detect a temporal segment within which the average SNR satisfies a given condition as a voiced temporal segment (in other words, as a breath temporal segment). Further, the calculation unit 3 detects a breath temporal segment indicative of an unvoiced temporal segment continuous to a rear end of a voiced temporal segment included in the input voice. The calculation unit 3 may detect, for example, a temporal segment within which the average SNR described above does not satisfy a given condition as an unvoiced temporal segment (in other words, as a breath temporal segment).

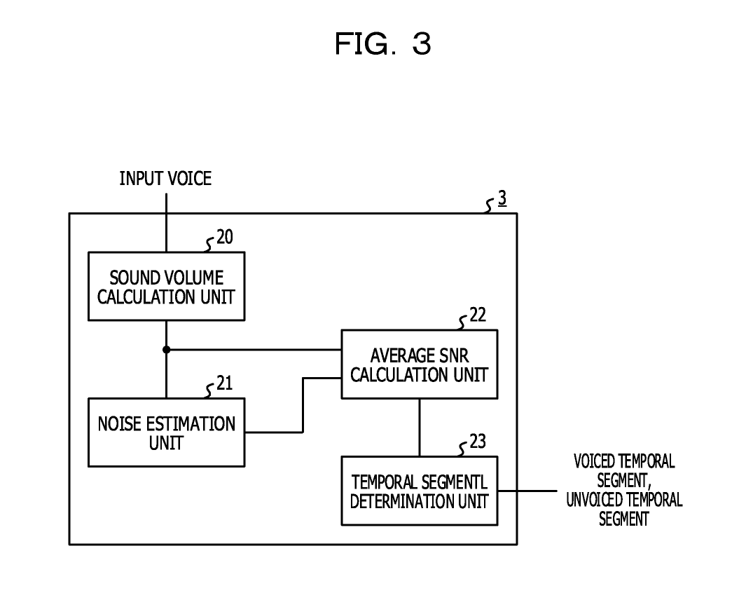

Here, details of a detection process of a voiced temporal segment and an unvoiced temporal segment by the calculation unit 3 are described. FIG. 3 is a functional block diagram of a calculation unit according to one embodiment. The calculation unit 3 includes a sound volume calculation unit 20, a noise estimation unit 21, an average SNR calculation unit 22, and a temporal segment determination unit 23. It is to be noted that the calculation unit 3 may not necessarily include the sound volume calculation unit 20, noise estimation unit 21, average SNR calculation unit 22, and temporal segment determination unit 23, but the functions provided by the components may be implemented by one or a plurality of hardware circuits configured from hard-wired logic. Alternatively, the functions provided by the components included in the calculation unit 3 may be implemented by a functional module implemented by a computer program executed by the voice processing device 1 in place of the hardware circuit by hard-wired logic.

In FIG. 3, an input voice is inputted to the sound volume calculation unit 20 through the calculation unit 3. It is to be noted that the sound volume calculation unit 20 has a buffer or a cache of a length M not depicted. The sound volume calculation unit 20 calculates a sound volume of each frame included in the input voice and outputs the sound volume to the noise estimation unit 21 and the average SNR calculation unit 22. It is to be noted that the length of frames included in the input voice is, for example, 0.2 msec. A sound volume S of each frame may be calculated in accordance with the following expression:

$$S ( n ) = {\sum }_{t = n * M}^{( n + 1 ) * M - 1} {c ( t )}^{2} \qquad ( Expression 1 )$$

It is to be noted that, in the (Expression 1) given above, n is a frame number successively applied to each frame after inputting of an acoustic frame included in the input voice is started (n is an integer equal to or greater than zero); M is a time length of one frame; t is time; and c(t) is an amplitude (power) of the input voice.

The noise estimation unit 21 receives a sound volume S(n) of each frame from the sound volume calculation unit 20. The noise estimation unit 21 estimates noise in each frame and outputs a result of the noise estimation to the average SNR calculation unit 22. Here, for the noise estimation of each frame by the noise estimation unit 21, for example, a (noise estimation method 1) or a (noise estimation method 2) given below may be used.

(Noise Estimation Method 1)

The noise estimation unit 21 may estimate a magnitude (power) N(n) of noise in each frame n on the basis of the sound volume S(n) in the frame n, sound volume S(n-1) in the preceding frame (n-1), and magnitude N(n-1) of noise in accordance with the following expression:

$$N ( n ) = \{ \begin{matrix}\begin{matrix}α \cdot N ( n - 1 ) + \\ ( 1 - α ) \cdot S ( n ) ,\end{matrix} & ( where \vert S ( n - 1 ) - S ( n ) \vert < β ) \\ N ( n - 1 ) , & ( else )\end{matrix} \qquad ( Expression 2 )$$

It is to be noted that, in the (Expression 2) above, α and β are constants and may be determined experimentally. For example, α may be equal to 0.9 and β may be equal to 2.0. Also the initial value N(−1) of the noise power may be determined experimentally. If, in the (Expression 2) given above, the sound volume S(n) of the frame n does not vary by equal to or more than the fixed value β with respect to the sound volume S(n-1) of the immediately preceding frame n-1, then the noise power N(n) of the frame n is updated. On the other hand, if the sound volume S(n) of the frame n varies by equal to or more than the fixed value β with respect to the sound volume S(n-1) of the immediately preceding frame n-1, then the noise power N(n-1) of the immediately preceding frame n-1 is determined as the noise power N(n) of the frame n. It is to be noted that the noise power N(n) may be referred to also as the noise estimation result described above.

(Noise Estimation Method 2)

The noise estimation unit 21 may update the magnitude of noise on the basis of the ratio between the sound volume S(n) of the frame n and the noise power N(n-1) of the immediately preceding frame n-1 and in accordance with the following (Expression 3):

$$N ( n ) = \{ \begin{matrix}\begin{matrix}α \cdot N ( n - 1 ) + \\ ( 1 - α ) \cdot S ( n ) ,\end{matrix} & ( where S ( n ) < γ \cdot N ( n - 1 ) ) \\ N ( n - 1 ) , & ( else )\end{matrix} \qquad ( Expression 3 )$$

It is to be noted that, in the (Expression 3) above, γ is a constant and may be determined experimentally. For example, γ may be equal to 2.0. Also the initial value N(−1) of the noise power may be determined experimentally. In the (Expression 3) above, if the sound volume S(n) of the frame n is equal to or smaller by a fixed value of γ times than the noise power N(n-1) of the immediately preceding frame n-1, then the noise power N(n) of the frame n is updated. On the other hand, if the sound volume S(n) of the frame n is equal to or greater by the fixed value of γ times than the noise power N(n-1) of the immediately preceding frame n-1, then the noise power N(n-1) of the immediately preceding frame n-1 is determined as the noise power N(n) of the frame n.

Referring to FIG. 3, the average SNR calculation unit 22 receives a sound volume S(n) of each frame from the sound volume calculation unit 20 and receives a noise power N(n) of each frame representative of a noise estimation result from the noise estimation unit 21. It is to be noted that the average SNR calculation unit 22 has a cache or a memory not depicted and retains the sound volume S(n) and the noise power N(n) for L frames in the past. The average SNR calculation unit 22 calculates an average SNR within an analysis target time period (frame) using the following expression and outputs the average SNR to the temporal segment determination unit 23.

$$SNR ( n ) = \frac{1}{L} {\sum }_{i = 0}^{L - 1} \frac{S ( n - i )}{N ( n - i )} \qquad ( Expression 4 )$$

It is to be noted that, in the (Expression 4) above, L may be set to a value higher than the value of a general length of an assimilated sound and may be, for example, determined in accordance with the number of frames corresponding to 0.5 msec.

The temporal segment determination unit 23 receives an average SNR from the average SNR calculation unit 22. The temporal segment determination unit 23 has a buffer or a cache not depicted, in which a flag n_breath indicative of whether or not a pre-processed frame by the temporal segment determination unit 23 is within a voiced temporal segment (in other words, within a breath temporal segment) is retained. The temporal segment determination unit 23 detects a start end tb of a voiced temporal segment in accordance with the following (Expression 5) and detects a last end to of the voiced temporal segment in accordance with the following (Expression 6) on the basis of the average SNR and the flag n_breath:

tb=n×M (Expression 5)

(if n_breath=not voiced temporal segment and SNR(n)>TH_{SNR})

te=n×M−1 (Expression 6)

(if n_breath=voiced temporal segment and SNR(n)<TH_{SNR})

Here, TH_{SNR} is a threshold value for the consideration by the temporal segment determination unit 23 that the processed frame does not have noise and may be determined experimentally. Further, the temporal segment determination unit 23 may detect a temporal segment of an input voice other than voiced temporal segments as an unvoiced temporal segment.

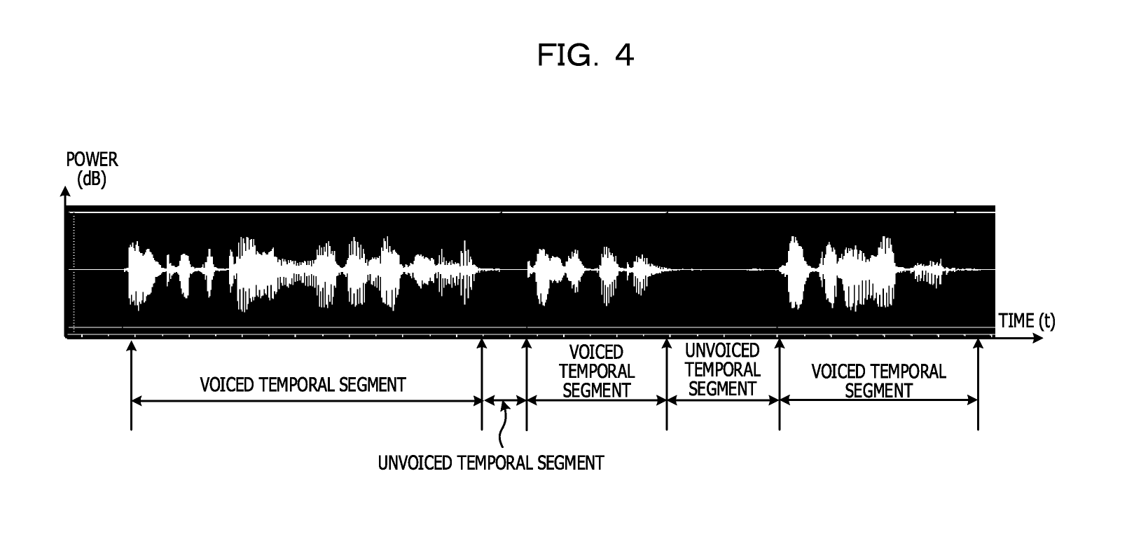

FIG. 4 is a diagram depicting a result of detection of a voiced temporal segment and an unvoiced temporal segment by a calculation unit. In FIG. 4, the axis of abscissa indicates the time, and the axis of ordinate indicates the sound volume (amplitude) of an input voice. As depicted in FIG. 4, a temporal segment continuous to the rear end of each voiced temporal segment is detected as an unvoiced temporal segment. Further, as depicted in FIG. 4, in detection of a voiced temporal segment by the calculation unit 3 disclosed in the working example 1, noise is learned in accordance with background noise, and a voiced temporal segment is discriminated on the basis of the SNR. Therefore, erroneous detection of a voiced temporal segment due to background noise may be reduced. Further, if an average SNR is calculated from a plurality of frames, then there is an advantage that, even if a period of time within which no voice is detected appears instantaneously within a voiced temporal segment, the period of time may be extracted as part of a continuous voiced temporal segment. It is to be noted that also it is possible for the calculation unit 3 to use the method described International Publication Pamphlet No. WO 2009/145192.

Now, a method of uniquely specifying a first voice, a second voice, a third voice, and a fourth voice from within a voiced temporal segment by the calculation unit 3 is described. It is to be noted that this process corresponds to step S203 of the flow chart depicted in FIG. 2. First, the calculation unit 3 may specify, by referring to a packet included in an input voice, whether the input voice is inputted to the first microphone 9 or to the second microphone 11. Here, for example, a method of uniquely specifying whether the input voice inputted to the first microphone 9 is the first voice of the first user or the second voice of the second user and specifying whether the input voice inputted to the second microphone 11 is the third voice of the first user or the fourth voice of the second user is described.

First, the calculation unit 3 identifies, for example, from the input voice inputted to the first microphone 9 and the input voice inputted to the second microphone 11, candidates for the first voice and the third voice, which represent the same utterance contents, on the basis of a first correlation between the first voice and the third voice. The calculation unit 3 calculates a first correlation R1(d) that is a cross-correlation between an arbitrary voiced temporal segment ci(t) included in the input voice inputted to the first microphone 9 and an arbitrary voiced temporal segment cj(t) included in the input voice inputted to the second microphone 11 in accordance with the following expression:

$$R 1 ( d ) = \frac{\begin{matrix}{\sum }_{t = tbi}^{tbi + L} ( ci ( t - d ) - \frac{{\sum }_{t = tbi}^{tbi + L} ci ( t - d )}{L} ) \\ ( cj ( t - m ) - \frac{{\sum }_{t = tbi}^{tbi + L} cj ( t - m )}{L} )\end{matrix}}{\sqrt{{\sum }_{t = tbi}^{tbi + L} {( ci ( t - d ) - \frac{{\sum }_{t = tbi}^{tbi + L} ci ( t - d )}{L} )}^{2}} \sqrt{{\sum }_{t = tbi}^{tbi + L} {( cj ( t - m ) - \frac{{\sum }_{t = tbi}^{tbi + L} cj ( t - m )}{L} )}^{2}}} \qquad ( Expression 7 )$$

It is to be noted that, in the (Expression 7) above, tbi is a start point of the voiced temporal segment ci(t), and tei is an end point of the voiced temporal segment ci(t). Further, tbj is a start point of the voiced temporal segment cj(t), and tej is an end point of the voiced temporal segment cj(t). Further, m=tbj−tbi, and L=tbe−tbi.

Further, when the maximum value of the first correlation R1(d) is higher than an arbitrary threshold value MAX_R (for example, MAX_R=0.95), the calculation unit 3 decides, in accordance with the expression given below, that the utterance contents within the voiced temporal segment ci(t) and within the voiced temporal segment cj(t) are same as each other (in other words, the calculation unit 3 associates the first voice and the third voice with each other).

$$Decision result = \begin{matrix}same utterance & if ( max ( R ( d ) ) > MAX\_R ) \\ not same utterance & else\end{matrix} \qquad ( Expression 8 )$$

It is to be noted that, if, in the (Expression 8) above, a difference |(tei−tbi)−(tej−tbj) | between lengths of the voiced temporal segments is greater than an arbitrary threshold value TH_dL (for example, TH_dL=1 second), then the voiced temporal segments may be excluded from a determination target in advance by determining that the utterance contents therein are different from each other. While the description of the working example 1 is directed to the identification method of candidates for the first voice and the third voice, the identification method of candidates for the first voice and the third voice may be similarly applied also to the identification method of candidates for the second voice and the fourth voice. The calculation unit 3 identifies candidates, for example, for the second voice and the fourth voice, which have the same utterance contents, from the input voice inputted from the first microphone 9 and the input voice inputted from the second microphone 11 on the basis of a second correlation R2(d) between the second voice and the fourth voice. To the second correlation R2(d), the right side of the (Expression 7) given hereinabove may be applied as it is.

Then, the calculation unit 3 identifies the voiced temporal segments associated with each other determining that they have the same utterance contents in regard to whether each of the voiced temporal segments includes the utterance of the first user or of the second user. For example, the calculation unit 3 compares average Root Mean Square (RMS) values representing voice levels (which may be referred to as amplitudes) of the two voiced temporal segments associated with each other determining that, for example, they have the same utterance contents (in other words, candidates for the first voice and the third voice or candidates for the second voice and the fourth voice identified in accordance with the (Expression 7) and the (Expression 8) given hereinabove). Then, the calculation unit 3 specifies the microphone from which the input voice including the voiced temporal segment that has a comparatively high value from between the average RMS values is inputted and may specify the user on the basis of the specified microphone. Further, by specifying the user, it is possible to uniquely specify the first voice and the second voice or to uniquely specify the third voice and the fourth voice. For example, if the positional relationship of the first user, second user, first microphone 9, and second microphone 11 in FIG. 1 is taken into consideration, then if the first user utters to the first microphone 9, then the utterance contents are inputted as the first voice to the first microphone 9. Simultaneously, a sound wave of the utterance contents propagates in the air and is inputted as the third voice to the second microphone 11. In this case, if attenuation of the sound wave is taken into consideration, then the input voice of the first user is inputted most to the first microphone 9 whose use by the first user is assumed, and, for example, the average RMS value is −27 dB. In this case, the average RMS value of the input voice of the first user inputted to the second microphone 11 is, for example, −50 dB. If it is considered that the input voice to the first microphone 9 is one of the first voice of the first user and the second voice of the second user, then it may be identified from the magnitude of the average RMS value that the input voice originates from the utterance of the first user. In this manner, the calculation unit 3 may distinguish the first voice and the third voice from each other on the basis of the amplitudes of the first voice and the third voice. Similarly, the calculation unit 3 may distinguish the second voice and the fourth voice from each other on the basis of the amplitudes of the second voice and the fourth voice.

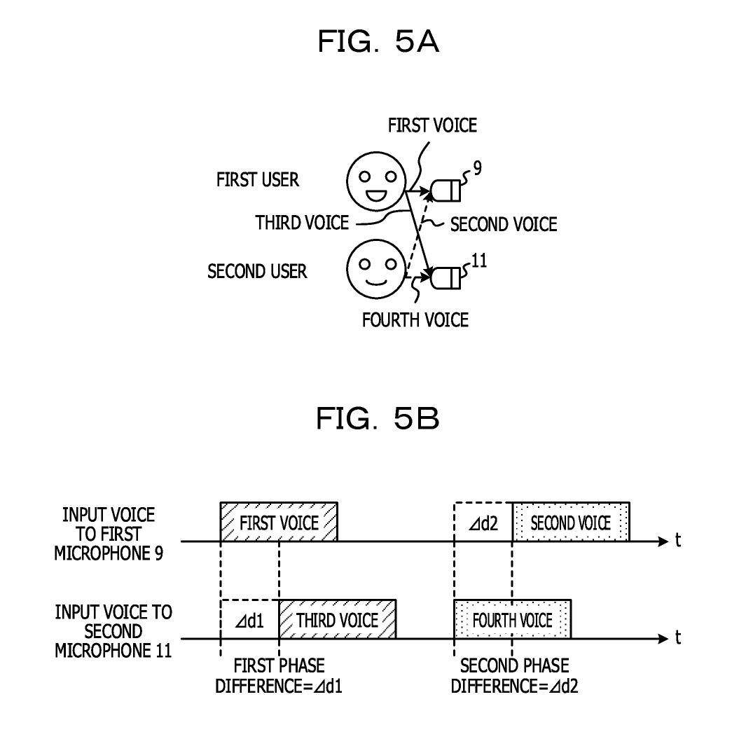

FIG. 5A is a view depicting a positional relationship of a first user, a second user, a first microphone, and a second microphone. As depicted in FIG. 5A, it is assumed for the convenience of description that, in the working example 1, the relative positions of the first user and the first microphone 9 are sufficiently near to each other and the relative positions of the second user and the second microphone 11 are sufficiently near to each other. Therefore, since the distance between the first user and the second microphone 11 and the distance between the second user and the first microphone 9 are similar to each other, also the delay amounts that occur when a sound wave propagates in the air are near to each other. In other words, a first phase difference when the input voice of the first user (first voice or third voice) reaches the first microphone 9 and the second microphone 11 and a second phase difference when the input voice of the second user (second voice or fourth voice) reaches the second microphone 11 and the first microphone 9 may be regarded near to each other.

FIG. 5B is a conceptual diagram of a first phase difference and a second phase difference. As depicted in FIG. 5B, the first voice of the first user and the second voice of the second user are inputted at an arbitrary time point (t) to the first microphone 9. To the second microphone 11, the third voice of the first user and the fourth voice of the second user are inputted at the arbitrary time point (t). As described hereinabove with reference to FIG. 5A, the first phase difference (which corresponds to a difference Δd1 in FIG. 5B) appears between the first voice and the third voice, and the second phase difference (which corresponds to a difference Δd2 in FIG. 5B) appears between the second voice and the fourth voice. The calculation unit 3 calculates the first phase difference, for example, with reference to the first voice and calculates the second phase difference, for example, with reference to the fourth voice. In particular, the calculation unit 3 may calculate the first phase difference by subtracting a time point of a start point of the third voice from a time point of a start point of the first voice, and may calculate the second phase difference by subtracting a time point of a start point of the second voice from a time point of a start point of the fourth voice. Further, the calculation unit 3 may calculate the first phase difference, for example, with reference to the third voice and calculate the second phase difference, for example, with reference to the second voice. In particular, the calculation unit 3 may calculate the first phase difference by subtracting the time point of the start point of the first voice from the time point of the start point of the third voice and calculate the second phase difference by subtracting the time point of the start point of the fourth voice from the time pint of the start point of the second voice. It is to be noted that the process described above corresponds to step S204 of the flow chart depicted in FIG. 2. The calculation unit 3 outputs the first and second phase differences calculated to the estimation unit 4. Further, the calculation unit 3 outputs the first, second, third, and fourth voices uniquely specified to the controlling unit 5.

The estimation unit 4 of FIG. 1 is a hardware circuit configured by hard-wired logic. The estimation unit 4 may be a functional module implemented by a computer program executed by the voice processing device 1. The estimation unit 4 receives a first phase difference and a second phase difference from the controlling unit 5. The estimation unit 4 estimates the distance between the first microphone 9 and the second microphone 11, or calculates a total value of the first and second phase differences, through comparison between the first and second phase differences. It is to be noted that the process just described corresponds to step S205 of the flow chart depicted in FIG. 2. For example, the estimation unit 4 multiplies a value (which may be referred to as average value), which is obtained by dividing the total value of the first and second phase differences by 2, by the speed of sound (for example, the speed of sound=343 m/s), and estimates the resulting value as the distance between the first microphone 9 and the second microphone 11. Particularly, the estimation unit 4 estimates an estimated distance dm between the first microphone 9 and the second microphone 11 in accordance with the following expression.

dm=(first phase difference+second phase difference)/2×vs (Expression 9)

It is to be noted that, in the (Expression 9) above, vs is the speed of sound. The estimation unit 4 may use comparison between the first and second phase differences to calculate the total value of the first and second phase differences in place of the estimation of the estimated distance. The estimation unit 4 outputs the estimated distance between the first microphone 9 and the second microphone 11 or the total value of the first and second phase differences to the controlling unit 5.

Here, the technological significance of the estimation of the distance between the first microphone 9 and the second microphone 11 through comparison of the first and second phase differences by the estimation unit 4 is described. As a result of intensive verification of the inventors of the present technology, the technological matters described below were found out newly. For example, when the first microphone 9 and the second microphone 11 or the first terminal 6 and the second terminal 7 are compared with each other, if one of the two microphones or the two terminals is in a state subject to an additional process such as, for example, noise reduction or velocity adjustment, then a delay Δt occurs as a result of the additional process. Further, the delay Δt is caused also by a difference between the line speed between the first terminal 6 and the network 117 and the line speed between the second terminal 7 and the network 117. Although the delay Δt by the difference in the line speeds does not originate from an additional process, it is assumed that the delay Δt is used in a unified manner for the convenience of description.

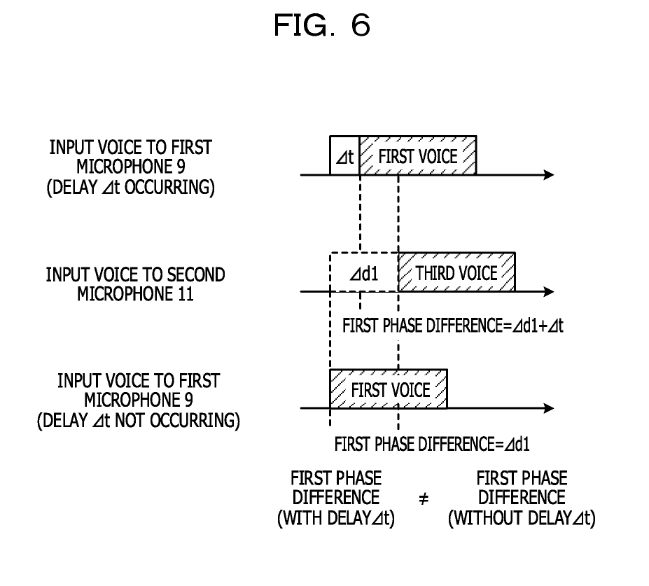

FIG. 6 is a conceptual diagram of occurrence of an error of an estimated distance by a delay. In FIG. 6, a concept of occurrence of an error of the estimated distance when a delay Δt occurs as a result of an additional process for the first microphone 9 is illustrated. To the reception unit 2 of FIG. 1, the first voice of the first user is inputted after lapse of the delay Δt. In the meantime, to the second microphone 11, the third voice of the first user is inputted without the delay Δt occurring. Here, the calculation unit 3 calculates the first phase difference by subtracting the time point of the start point of the third voice from the time point of the start point of the first voice as described hereinabove. However, due to an influence of the delay Δt, the time point of the start point of the first voice is different from the original start point (the end point of the delay Δt becomes the start point of the first voice). Therefore, the calculation unit 3 comes to calculate the first phase difference by subtracting the time point of the start point of the third voice from the time point of the end point of the delay Δt. In this case, since the first phase difference is different from the original first phase difference (which corresponds to the difference Δd1) when the delay Δt does not occur, an error occurs in the estimated distance between the first microphone 9 and the second microphone 11. For example, where the delay Δt is 30 msec, the error in the estimated distance is approximately 10 m. In other words, if the estimation unit 4 estimates the distance between the first microphone 9 and the second microphone 11 on the basis of only one of the first and second phase differences, then an error sometimes occurs in the estimated distance.

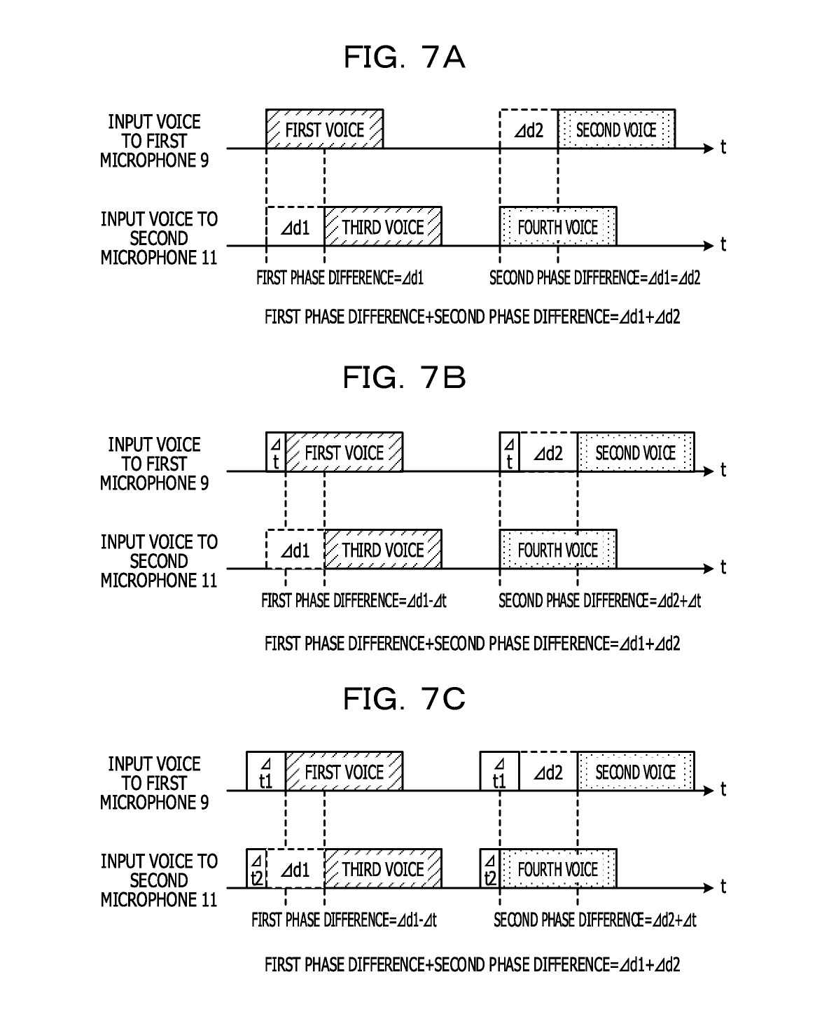

FIG. 7A is a conceptual diagram of first and second phase differences when a delay does not occur. As depicted in FIG. 7A, to the first microphone 9, the first voice of the first user and the second voice of the second user are inputted at an arbitrary time point (t). Between the first voice and the third voice and between the second voice and the fourth voice, only a phase difference (which corresponds, in FIG. 7A, to a difference Δd1 and another difference Δd2) that occurs when a sound wave propagates in the air occurs. Therefore, as depicted in FIG. 7A, when the delay Δt does not occur, the first phase difference is equal to the difference Δd1 and the second phase difference is equal to the difference Δd2. In this case, the “total of the first and second phase differences is Δd1+Δd2.”

FIG. 7B is a conceptual diagram of first and second phase differences when a delay occurs in a first microphone. As depicted in FIG. 7B, when the delay Δt occurs in the first microphone 9, the first phase difference calculated by the calculation unit 3 is Δd1−Δt, and the second phase difference is Δd2+Δt. In this case, the “total of the first and second phase differences is Δd1+Δd2” (Δt in the first and second phase differences cancel each other to zero). Therefore, the total of the first and second phase differences when the delay Δt occurs in the first microphone 9 is equal to the total of the first and second phase differences when no delay occurs.

FIG. 7C is a conceptual diagram of first and second phase differences when a delay occurs in both of first and second microphones. It is to be noted that, for the convenience of description, the delay in the first microphone 9 is represented by Δt1 and the delay in the second microphone 11 is represented by Δt2. As depicted in FIG. 7C, the first phase difference calculated by the calculation unit 3 is given by “Δd1−(Δt1−Δt2),” and the second phase difference is given by “Δd2+(Δt1−Δt2).” In this case, the “total of the first and second phase differences is Δd1+Δd2” (Δt1 and Δt2 in the first and second phase differences cancel each other to zero). By comparing the first and second phase differences (in other words, by using the total values) in this manner, the distance between the first microphone 9 and the second microphone 11 may be estimated accurately by the estimation unit 4 irrespective of presence or absence of occurrence of a delay.

Further, a qualitative reason why the distance between the first microphone 9 and the second microphone 11 may be estimated accurately through comparison between the first and second phase differences by the estimation unit 4 is described. Since the first voice and the third voice of the first user are inputted to the first microphone 9 and the second microphone 11, respectively, a phase difference between the input voices of the first user to the first microphone 9 and the second microphone 11 may be obtained. Further, since the second voice and the fourth voice of the second user are inputted to the first microphone 9 and the second microphone 11, respectively, a phase difference between the input voices of the second user to the first microphone 9 and the second microphone 11 may be obtained.

Here, for example, where the delay amount until the input voice is inputted to the reception unit 2 of the voice processing device 1 is different between the first microphone 9 and the second microphone 11, for example, if the phase difference between the voices of the first user is determined with reference to the first microphone 9 used by the first user, then the determined phase difference is equal to the total value of the phase difference caused by the distance between the users and the delay in the other microphone (second microphone 11) with respect to the delay in the reference microphone (first microphone 9). Therefore, the phase difference between the voices of the first user is the total value of the delay amount caused by the distance between the first user and the second user and the delay amount in the second microphone 11 with respect to the first microphone 9. Meanwhile, the phase difference between the voices of the second user is the total value of the delay amount caused by the distance between the first user and the second user and the delay amount in the first microphone 9 with respect to the second microphone 11. Since the delay amount in the second microphone 11 with respect to the first microphone 9 and the delay amount by the first microphone 9 with respect to the second microphone 11 are equal in absolute value but are different in sign, by combining the phase difference in voice of the first user and the phase difference in voice of the second user, the delay amount in the second microphone 11 with respect to the first microphone 9 and the delay mount in the first microphone 9 with respect to the second microphone 11 may be removed from the phase difference.

Referring to FIG. 1, the controlling unit 5 is a hardware circuit configured, for example, by hard-wired logic. The controlling unit 5 may otherwise be a functional module implemented by a computer program executed by the voice processing device 1. The controlling unit 5 receives an estimated distance between the first microphone 9 and the second microphone 11 from the estimation unit 4 or a total value of the first and second phase differences. Further, the controlling unit 5 receives the uniquely specified first, second, third, and fourth voices from the calculation unit 3. When the estimated distance between the first microphone 9 and the second microphone 11 or the total value of the first and second phase differences is lower than a given first threshold value (for example, 2 m or 12 msec), the controlling unit 5 controls transmission of the second voice or the fourth voice to the first speaker 10 positioned nearer to the first user than the second user and controls transmission of the first voice or the third voice to the second speaker 12 positioned nearer to the second user than the first user. In particular, when the estimated distance between the first microphone 9 and the second microphone 11 or the total value of the first and second phase differences is smaller than the first threshold value, since this fact signifies that the distance between the first user and the second user is small, both users hear the voices of the opponents from two sounds of communication reception sound and direct sound in a superposed relationship in a state in which the voices have a time difference therebetween. Therefore, the controlling unit 5 controls the first speaker not to output the second voice or the fourth voice which are voices of the second user. Meanwhile, the controlling unit 5 controls the second speaker not to output the first voice or the third voice which are voices of the first user. It is to be noted that the process just described corresponds to step S206 of the flow chart depicted in FIG. 2. By the control described, the users in the near distance hear the voices of the opponents only from respective direct sounds, and therefore, there is an effect that the voices may be caught easily.

Further, when the estimated distance between the first microphone 9 and the second microphone 11 or the total value of the first and second phase differences is equal to or greater than the given first threshold value, the controlling unit 5 controls transmission of a plurality of voices (for example, the second voice and the fourth voice) other than the first voice or the third voice to the first speaker 10 and controls transmission of a plurality of voices (for example, the first voice and the third voice) other than the second voice or the fourth voice to the second speaker 12. In particular, when the estimated distance between the first microphone 9 and the second microphone 11 or the total value of the first and second phase differences is equal to or greater than the first threshold value, since this fact signifies that the distance between the first user and the second user is great, the users hear the voices of the opponents only from communication reception sound. Therefore, the controlling unit 5 controls the first speaker 10 to output voices other than the first voice or the third voice which are voices of the first user. Meanwhile, the controlling unit 5 controls the second speaker 12 to output voices other than the second voice or the fourth voice which are voices of the second user. As a result of the control described, the first user or the second user is placed out of a situation in which the voice of the first user or the second user itself is heard from both of communication reception sound and direct sound in a superposed relationship with a time lag interposed therebetween. Therefore, there is an advantage that the voices may be heard easily.

In the voice processing device 1 of the working example 1, when a plurality of users communicate with each other, the distance between the users is estimated accurately. Further, where the distance between the users is small, the users are placed out of a situation in which the voices of the opponents are heard from both of communication reception sound and direct sound in a superposed relationship with a time lag interposed therebetween. Therefore, the voices may be heard easily.

### WORKING EXAMPLE 2

While, in the description of the working example 1, a voice process whose subject is a first user and a second user is described, also where three or more users communicate with each other, the present embodiment may accurately estimate the distances between the users. Therefore, in the description of a working example 2, a voice process whose subject is the first terminal 6 corresponding to the first user to the nth terminal 8 corresponding to the nth user of FIG. 1 is described.

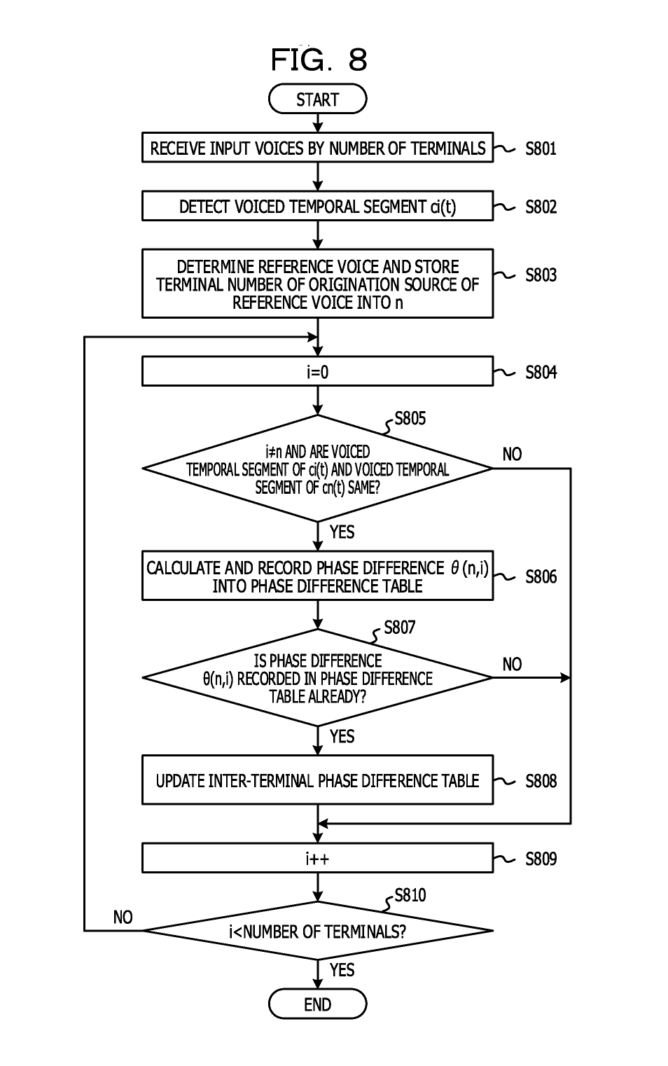

FIG. 8 is a second flow chart of a voice process of a voice processing device. The reception unit 2 receives a plurality of input voices (which may be referred to as a plurality of voices) inputted to the first microphone 9 to nth microphone 13 through the first terminal 6 to nth terminal 8 and the network 117 that is an example of a communication network. In other words, the reception unit 2 receives a number of input voices equal to the number of terminals (first terminal 6 to nth terminal 8) coupled to the voice processing device 1 through the network 117 (step S801). The calculation unit 3 detects a voiced temporal segment ci(t) of each of the plurality of input voices on the basis of the method described in the foregoing description of the working example 1 (step S802).

The calculation unit 3 determines a reference voice and stores a terminal number of an origination source of the reference voice into n (step S803). In particular, at step S803, the calculation unit 3 calculates, for each voiced temporal segment of each of the plurality of input voices, a voice level vi in accordance with the following expression:

$${v}_{i} = {\sum }_{t = {t}_{bi}}^{{t}_{ei}} {{c}_{i} ( t )}^{2} \qquad ( Expression 10 )$$

In the (Expression 10) above, ci(t) is an input voice i from the ith terminal, and vi is a voice level of the input voice i. tbi and tei are a start frame (which may be referred to as start point) and an end frame (which may be referred to as end point) of a voiced temporal segment of the input voice i, respectively. Then, the calculation unit 3 compares the values of a plurality of voice levels vi calculated in accordance with the (Expression 10) given above with each other and estimates the input voice i having the highest value as the terminal number of the origination source of the utterance. In the description of the working example 2, the following description is given assuming that the terminal number estimated as the origination source is n (nth terminal 8) for the convenience of description.

The calculation unit 3 sets i=0 (step S804) and then determines whether or not conditions at step S805 (that i not equal n and that a voiced temporal segment of ci(t) and a voiced temporal segment of cn(t) are the same as each other) are satisfied, for example, on the basis of the (Expression 7) and the (Expression 8) given above. If the conditions at step S805 are satisfied (Yes at step S805), then the calculation unit 3 specifies the mth input voice i that satisfies the condition of the same voiced temporal segment as the input voice km. It is to be noted that, if the conditions at step S805 are not satisfied (No at step S805), then the processing advances to step S809.

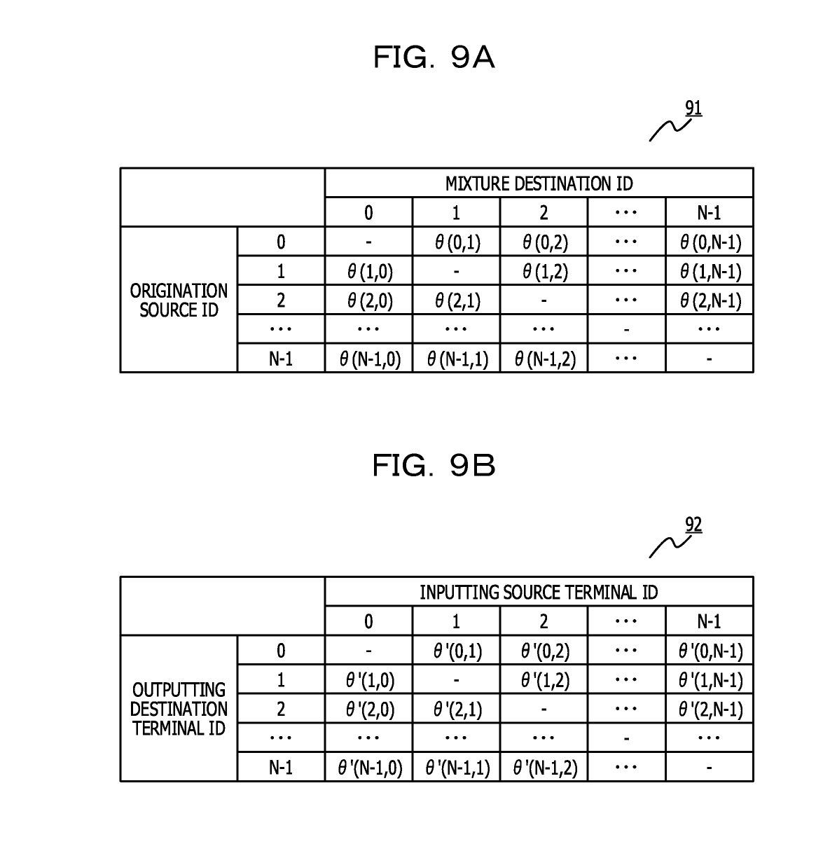

FIG. 9A depicts an example of a data structure of a phase difference table. FIG. 9B depicts an example of a data structure of an inter-terminal phase difference table. In a table 91 depicted in FIG. 9A, an origination source ID of an input voice and a phase difference of a mixture destination ID of a mixture destination into which the input voice is mixed are stored. In a table 92 depicted in FIG. 9B, a phase difference between terminals (which correspond to the first terminal 6 to nth terminal 8: also it is possible to consider that the terminals correspond to the first microphone 9 to the nth microphone 13) is stored. The calculation unit 3 calculates a phase difference θ(n, km) between the input voice n and the input voice km in accordance with the expression given below and records the calculated phase difference θ(n, km) into the table 91 depicted in FIG. 9A (step S806). It is to be noted that the table 91 and the table 92 may be recorded, for example, into a cache or a memory not depicted of the calculation unit 3.

θ(n, km)=tbn−tbkm (Expression 11)

Then, the calculation unit 3 refers to the table 91 to decide whether or not the phase difference θ(km, n) between the input voice n and the input voice km is recorded already in the table 92 (step S807). If the phase difference θ(km, n) is recorded already (Yes at step S807), then the calculation unit 3 updates the value of the table 92 on the basis of the expression given below (step S808). It is to be noted that the condition at step S807 is not satisfied (No at step S807), then the processing advances to step S809.

θ(n, km)=(θ(n, km)+θ(km, n))/2

θ(km, n)=(θ(n, km)+θ(km, n))/2 (Expression 11)

In the (Expression 12) above, θ(km, n) has a value calculated in accordance with the following expression when the terminal number estimated as the origination source is km and the voiced temporal segment of ckm(t) is same as the voiced temporal segment of cn(t):

θ(km, n)=tbkm−tbn (Expression 13)

It is to be noted that an initial value of the table 92 may be set to a value equal to or higher than an arbitrary threshold value TH_OFF indicative of the fact that the distance between the terminals (between the microphones) is sufficiently great. Also it is to be noted that the value of the threshold value TH_OFF may be, for example, 30 ms that is a phase difference arising from a distance of, for example, approximately 10 m. Alternatively, the value of the threshold value TH_OFF may be inf indicating that the threshold value TH_OFF is equal to or higher than a value that may be set.

After the process at step S808 is completed or when the condition of No at step S805 or No at step S807 is satisfied, the calculation unit 3 increments i (step S809) and then decides whether or not i is smaller than the number of terminals (step S810). If the condition at step S810 is not satisfied (No at step S810), then the processing returns to step S804. If the condition at step S810 is satisfied (Yes at step S810), then the voice processing device 1 completes the process depicted in the flow chart of FIG. 8.

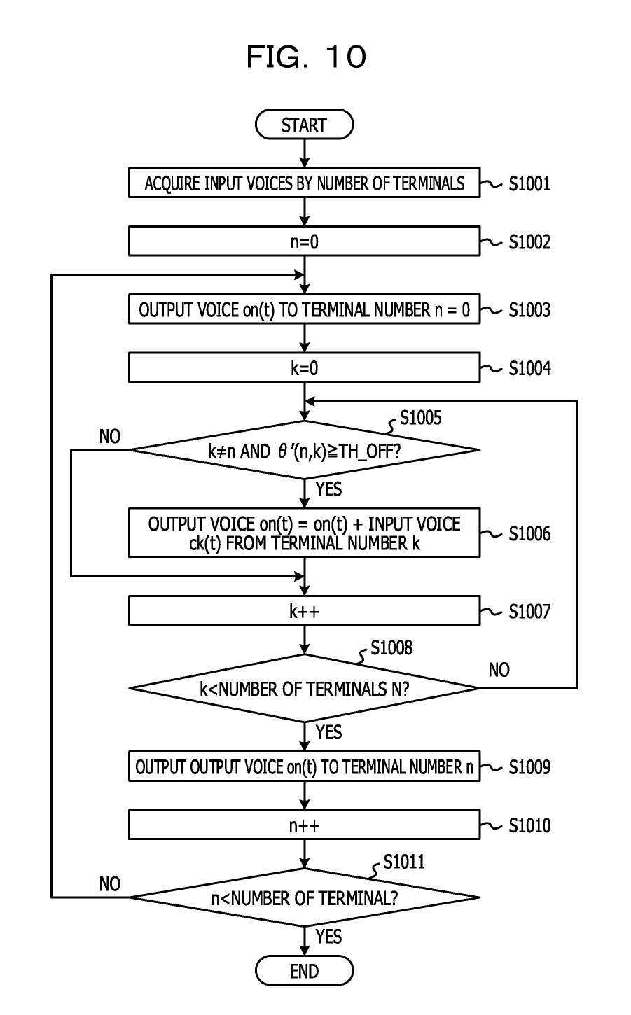

Now, a controlling method of an output voice based on the table 92 by the voice processing device 1 is described. FIG. 10 is a third flow chart of a voice process of a voice processing device. Referring to FIG. 10, the controlling unit 5 acquires, for each frame, an input voice ci(t) for one frame from all terminals (corresponding to the first terminal 6 to nth terminal 8) (step S1001). Then, the controlling unit 5 refers to the table 92 to control the output voice of the terminals of the terminal number 0 to the terminal number N-1. In the description of the working example 2, a controlling method of an output voice to the terminal number n (nth terminal 8) is described for the convenience of description. The controlling unit 5 sets n to n=0 (step S1002) and initializes an output voice on(t) to the terminal number n with 0 (on(t)=0) (step S1003).

Then, the controlling unit 5 sets the terminal numbers k other than the terminal number m to 0 (step S1004). The controlling unit 5 refers to the table 92 to detect an inter-terminal phase difference θ(n, k) between the terminal number n and the terminal number k in regard to the terminal numbers k (k not equal n, k=0, . . . , N-1) other than the terminal number n and decides whether or not the inter-terminal phase difference θ is smaller than the threshold value TH_OFF (step S1005). If the condition at step S1005 is not satisfied (No at step S1005), then the processing is advanced to step S1007. If the condition at step S1005 is satisfied (Yes at step S1005), then the controlling unit 5 updates the output voice on(t) in accordance with the following expression (step S1006):

on(t)=on(t)+ck(t) (Expression 14)

After the process at step S1006 is completed or in the case of No at step S1005, the controlling unit 5 increments k (step S1007) and decides whether or not the number of the terminal numbers k is smaller than the number of terminals N (step S1008). If the condition at step S1008 is not satisfied (No at step S1008), then the processing returns to step S1005. However, if the condition at step S1008 is satisfied (Yes at step S1008), then the controlling unit 5 outputs the output voice on(t) to the terminal number n (step S1009). Then, the controlling unit 5 increments n (step S1010) and decides whether or not n is smaller than the number of terminals (step S1011). If the condition at step S1011 is not satisfied (No at step S1011), then the processing returns to the process at step S1003. If the condition at step S1011 is satisfied (Yes at step S1011), then the voice processing device 1 completes the process illustrated in the flow chart of FIG. 10.

### WORKING EXAMPLE 3

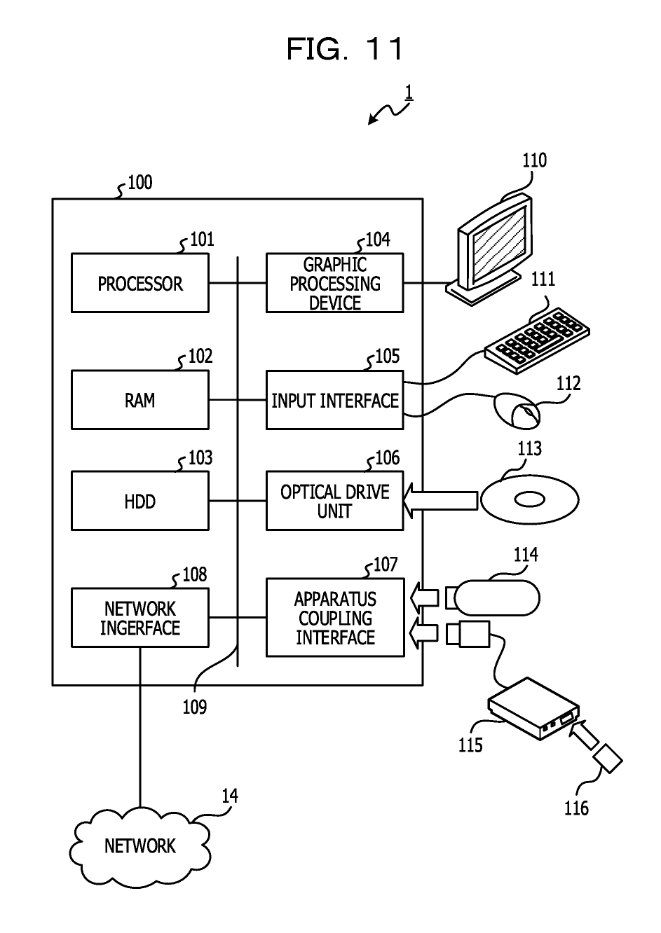

FIG. 11 is a view of a hardware configuration of a computer that functions as a voice processing device according to one embodiment. As depicted in FIG. 11, the voice processing device 1 includes a computer 100 and inputting and outputting apparatus (peripheral apparatus) coupled to the computer 100.

The computer 100 is controlled entirely by a processor 101. To the processor 101, a Random Access Memory (RAM) 102 and a plurality of peripheral apparatuses are coupled through a bus 109. It is to be noted that the processor 101 may be a multiprocessor. Further, the processor 101 is, for example, a Central Processing Unit (CPU), a Micro Processing Unit (MPU), a Digital Signal Processor (DSP), an Application Specific Integrated Circuit (ASIC) or a Programmable Logic Device (PLD). Further, the processor 101 may be a combination of two or more of a CPU, an MPU, a DSP, an ASIC, and a PLD. It is to be noted that, for example, the processor 101 may execute processes of functional blocks such as the reception unit 2, calculation unit 3, estimation unit 4, controlling unit 5 and so forth depicted in FIG. 1.

The RAM 102 is used as a main memory of the computer 100. The RAM 102 temporarily stores at least part of a program of an Operating System (OS) and application programs to be executed by the processor 101. Further, the RAM 102 stores various data to be used for processing by the processor 101. The peripheral apparatuses coupled to the bus 109 include a Hard Disk Drive (HDD) 103, a graphic processing device 104, an input interface 105, an optical drive unit 106, an apparatus coupling interface 107, and a network interface 108.

The HDD 103 performs writing and reading out of data magnetically on and from a disk built therein. The HDD 103 is used, for example, as an auxiliary storage device of the computer 100. The HDD 103 stores a program of an OS, application programs, and various data. It is to be noted that also a semiconductor storage device such as a flash memory may be used as an auxiliary storage device.

A monitor 110 is coupled to the graphic processing device 104. The graphic processing device 104 controls the monitor 110 to display various images on a screen in accordance with an instruction from the processor 101. The monitor 110 may be a display unit that uses a Cathode Ray Tube (CRT), a liquid crystal display unit or the like.

To the input interface 105, a keyboard 111 and a mouse 112 are coupled. The input interface 105 transmits a signal sent thereto from the keyboard 111 or the mouse 112 to the processor 101. It is to be noted that the mouse 112 is an example of a pointing device and may be configured using a different pointing device. As the different pointing device, a touch panel, a tablet, a touch pad, a track ball and so forth are available.

The optical drive unit 106 performs reading out of data recorded on an optical disc 113 utilizing a laser beam or the like. The optical disc 113 is a portable recording medium on which data are recorded so as to be read by reflection of light. As the optical disc 113, a Digital Versatile Disc (DVD), a DVD-RAM, a Compact Disc Read Only Memory (CD-ROM), a CD-R (Recordable)/RW (ReWritable) and so forth are available. A program stored on the optical disc 113 serving as a portable recording medium is installed into the voice processing device 1 through the optical drive unit 106. The given program installed in the voice processing device 1 is enabled for execution.

The apparatus coupling interface 107 is a communication interface for coupling a peripheral apparatus to the computer 100. For example, a memory device 114 or a memory reader-writer 115 may be coupled to the apparatus coupling interface 107. The memory device 114 is a recording medium that incorporates a communication function with the apparatus coupling interface 107. The memory reader-writer 115 is an apparatus that performs writing of data into a memory card 116 and reading out of data from the memory card 116. The memory card 116 is a card type recording medium.

The network interface 108 is coupled to the network 117. The network interface 108 performs transmission and reception of data to and from a different computer or a communication apparatus through the network 117. For example, the network interface 108 receives a plurality of input voices (which may be referred to as a plurality of voices) inputted to the first microphone 9 to nth microphone 13 depicted in FIG. 1 through the first terminal 6 to nth terminal 8 and the network 117.

The computer 100 implements the voice processing function described hereinabove by executing a program recorded, for example, on a computer-readable recording medium. A program that describes the contents of processing to be executed by the computer 100 may be recorded on various recording media. The program may be configured from one or a plurality of functional modules. For example, the program may be configured from functional modules that implement the processes of the reception unit 2, calculation unit 3, estimation unit 4, controlling unit 5 and so forth depicted in FIG. 1. It is to be noted that the program to be executed by the computer 100 may be stored in the HDD 103. The processor 101 loads at least part of the program in the HDD 103 into the RAM 102 and executes the program. Also it is possible to record a program, which is to be executed by the computer 100, in a portable recording medium such as the optical disc 113, memory device 114, or memory card 116. A program stored in a portable recording medium is installed into the HDD 103 and then enabled for execution under the control of the processor 101. Also it is possible for the processor 101 to directly read out a program from a portable recording medium and then execute the program.

The components of the devices and the apparatus depicted in the figures need not necessarily be configured physically in such a manner as in the figures. In particular, a particular form of integration or disintegration of the devices and apparatus is not limited to that depicted in the figures, and all or part of the devices and apparatus may be configured in a functionally or physically integrated or disintegrated manner in an arbitrary unit in accordance with loads, use situations and so forth of the devices and apparatus. Further, the various processes described in the foregoing description of the working examples may be implemented by execution of a program prepared in advance by a computer such as a personal computer or a work station.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A voice processing device, comprising:
a processor; and
a memory which stores a plurality of instructions, which when executed by the processor, cause the processor to execute:
receiving, through a communication network,
a first voice of a first user and a second voice of a second user inputted to a first microphone positioned nearer to the first user than the second user, and
a third voice of the first user and a fourth voice of the second user inputted to a second microphone positioned nearer to the second user than the first user;
calculating a first phase difference between the received first voice and the received second voice and a second phase difference between the received third voice and the received fourth voice; and
performing at least one of:
controlling transmission of the received second voice or the received fourth voice to a first speaker positioned nearer to the first user than the second user on the basis of the first phase difference and the second phase difference, and
controlling transmission of the received first voice or the received third voice to a second speaker positioned nearer to the second user than the first user on the basis of the first phase difference and the second phase difference.

2. The device according to claim 1, wherein the calculating includes at least one of:
calculating the first phase difference with reference to the received first voice and calculating the second phase difference with reference to the received fourth voice; and
calculating the first phase difference with reference to the received third voice and calculating the second phase difference with reference to the received second voice.

3. The device according to claim 1, wherein the calculating
identifies, from among the received first, second, third and fourth voices, the received first voice and the received third voice on the basis of a first correlation which is a first cross-correlation between the received first voice and the received third voice; and
identifies, from among the received first, second, third and fourth voices, the received second voice and the received fourth voice on the basis of a second correlation which is a second cross-correlation between the received second voice and the received fourth voice.

4. The device according to claim 1, wherein the calculating
distinguishes the received first voice and the received second voice on the basis of an amplitude of the received first voice and the received third voice; and
distinguishes the received third voice and the received fourth voice on the basis of an amplitude of the received second voice and the received fourth voice.

5. The device according to claim 1, further comprising:
estimating a distance between the first microphone and the second microphone on the basis of the first phase difference and the second phase difference.

6. The device according to claim 5, wherein the estimating
estimates the distance on the basis of a total value of the first phase difference and the second phase difference.

7. The device according to claim 5, wherein, when the estimated distance is smaller than a first threshold value,
the controlling transmission of the received second voice or the received fourth voice prevents transmission of the received second voice or the received fourth voice to the first speaker; and
the controlling transmission of the received first voice or the received third voice prevents transmission of the received first voice or the received third voice to the second speaker.

8. The device according to claim 5, wherein, when the estimated distance is equal to or greater than a first threshold value,
the controlling transmission of the received second voice or the received fourth voice controls transmission so that the received second voice or the received fourth voice is output from the first speaker; and
the controlling transmission of the received first voice or the received third voice controls transmission so that the received first voice or the received third voice is output from the second speaker.

9. The device according to claim 1, wherein the calculating
calculates the first phase difference by subtracting a third time point of a third start point of the third voice from a first time point of a first start point of the first voice and calculates the second phase difference by subtracting a second time point of a second start point of the second voice from a fourth time point of a fourth start point of the fourth voice; or
calculates the first phase difference by subtracting the first time point from the third time point and calculates the second phase difference by subtracting the fourth time point from the second time point.

10. The device according to claim 5, wherein the estimating estimates the distance on the basis of a total value of
the first phase difference including a first delay amount for the recieving and
the second phase difference including a second delay amount for the receiving, the second delay amount is equal in absolute value but is different in sign against the first delay amount.

11. The device according to claim 1, further comprising:
estimating a distance between the first microphone and the second microphone on the basis of the first phase difference and the second phase difference, wherein
the controlling transmission of the received second voice or the received fourth voice controls transmission of the received second voice or the received fourth voice on the basis of the estimated distance, and
the controlling transmission of the received first voice or the received third voice controls transmission of the received first voice or the received third voice on the basis of the estimated distance.

12. A voice processing method, comprising:
receiving, through a communication network,
a first voice of a first user and a second voice of a second user inputted to a first microphone positioned nearer to the first user than the second user, and
a third voice of the first user and a fourth voice of the second user inputted to a second microphone positioned nearer to the second user than the first user;
calculating a first phase difference between the received first voice and the received second voice and a second phase difference between the received third voice and the received fourth voice; and
performing at least one of:
controlling, by a computer processor, transmission of the received second voice or the received fourth voice to a first speaker positioned nearer to the first user than the second user on the basis of the first phase difference and the second phase difference, and
controlling transmission of the received first voice or the received third voice to a second speaker positioned nearer to the second user than the first user on the basis of the first phase difference and the second phase difference.

13. The method according to claim 12, wherein the calculating includes at least one of:
calculating the first phase difference with reference to the received first voice and calculating the second phase difference with reference to the received fourth voice; and
calculating the first phase difference with reference to the received third voice and calculating the second phase difference with reference to the received second voice.

14. The method according to claim 12, wherein the calculating
identifies, from among the received first, second, third and fourth voices, the received first voice and the received third voice on the basis of a first correlation which is a first cross-correlation between the received first voice and the received third voice; and
identifies, from among the received first, second, third and fourth voices, the received second voice and the received fourth voice on the basis of a second correlation which is a second cross-correlation between the received second voice and the received fourth voice.

15. The method according to claim 12, wherein the calculating
distinguishes the received first voice and the received second voice on the basis of an amplitude of the received first voice and the received third voice; and
distinguishes the received third voice and the received fourth voice on the basis of an amplitude of the received second voice and the received fourth voice.

16. The method according to claim 12, further comprising:
estimating a distance between the first microphone and the second microphone on the basis of the first phase difference and the second phase difference.

17. The method according to claim 16, wherein the estimating estimates the distance on the basis of a total value of the first phase difference and the second phase difference.

18. The method according to claim 16, wherein, when the estimated distance is smaller than a first threshold value,
the controlling transmission of the received second voice or the received fourth voice prevents transmission of the received second voice or the received fourth voice to the first speaker; and
the controlling transmission of the received first voice or the received third voice prevents transmission of the received first voice or the received third voice to the second speaker.

19. The method according to claim 16, wherein, when the estimated distance is equal to or greater than a first threshold value,
the controlling transmission of the received second voice or the received fourth voice controls transmission so that the received second voice or the received fourth voice is output from the first speaker; and
the controlling transmission of the received first voice or the received third voice controls transmission so that the received first voice or the received third voice is output from the second speaker.

20. A computer-readable non-transitory medium that stores a voice processing program for causing a computer to execute a process comprising:
receiving, through a communication network,
a first voice of a first user and a second voice of a second user inputted to a first microphone positioned nearer to the first user than the second user, and
a third voice of the first user and a fourth voice of the second user inputted to a second microphone positioned nearer to the second user than the first user;
calculating a first phase difference between the received first voice and the received second voice and a second phase difference between the received third voice and the received fourth voice; and
performing at least one of:
controlling transmission of the received second voice or the received fourth voice to a first speaker positioned nearer to the first user than the second user on the basis of the first phase difference and the second phase difference, and
controlling transmission of the received first voice or the received third voice to a second speaker positioned nearer to the second user than the first user on the basis of the first phase difference and the second phase difference.
